(19) United States
(12) Patent Application Publication
(10) Pub. No.: US 2011/0317918 A1
(43) Pub. Date: Dec. 29, 2011

(54) METHOD FOR CHANGING AN IMAGE DATA SIGNAL, DEVICE FOR CHANGING AN IMAGE DATA SIGNAL, DISPLAY DEVICE

(75) Inventors: Rui Filipe Cardoso Guerreiro, Eindhoven (PT); Jeroen Arnoldus Paulus Tegenbosch, Eindhoven (NL); Yingrong Xie, Eindhoven (NL); Michiel Adriaanszoon Klompenhouwer, Eindhoven (NL)

(73) Assignee: KONINKLIJKE PHILIPS ELECTRONICS N.V., Eindhoven (NL)

(21) Appl. No.: 13/141,173

(22) PCT Filed: Dec. 18, 2009
(86) PCT No.: PCT/IB2009/055843

§ 371 Date: Jun. 22, 2011

(30) Foreign Application Priority Data
Dec. 22, 2008 (EP) 08172493.2

(51) Int. Cl. G06K 9/00

(52) U.S. Cl. 382/167

(57) ABSTRACT

In a method for color enhancement the color distance between spatially close colored pixel or pixel areas does not change more than a threshold, the threshold being a function of the initial color distance. The color difference between pixels that are close together and did not differ much in color will be restricted. This reduces the change on unnatural looking parts of an image and allows more pronounced color enhancement to be 5 used.

### FIELD OF THE INVENTION

The present invention relates to a method for changing an image data signal comprising pixel data, the pixel data comprising a color value, in which method the color values for pixels are transformed from a color value into a transformed color value.

The invention also relates to a device for changing color image data, said device comprising a color enhancer for color enhancement of image data.

The invention also relates to a display device comprising a device for changing color image data.

### BACKGROUND OF THE INVENTION

Changing the color of parts of an image, often in the form of color enhancement, is very important in picture quality improvement. It makes colors seem livelier and more pleasant to watch, which is especially relevant in new display technologies that exhibit increased color gamut. Color enhancement can also be used to correct for unwanted color changes during processing of a data signal.

In either case it is a very relevant issue in the consumer business, since it allows differentiation from the competition.

Current color enhancement techniques transform a color value for a pixel into another color value through the use of a mathematical function that varies according to the color values. Green is made greener, red redder etcetera.

Although color enhancement techniques provide a livelier image, it has become apparent to the inventors that often unnatural color effects occur. These annoying effects limit the possible color enhancement.

It is an object of the invention to provide a method for color changing in which this problem is reduced.

### SUMMARY OF THE INVENTION

To this end the method in accordance with the invention is characterized in that the color value changes to pixels or pixel areas are applied in such manner that the color value changes for neighboring pixels or pixel areas are restricted by an increase of the color distance between said neighboring pixels or pixel areas below a threshold value, the threshold value being a function of the initial color distance, increasing as the color distance between neighboring pixels or pixel areas increases.

The inventors have realized that, since different colors have typically different enhancements, known color enhancement algorithms tend to produce unbalanced un-natural images, unless the enhancement is restricted to a very moderate level.

In the method of the invention the surroundings of a pixel or pixel area are taken into consideration for the color change applied to a pixel or pixel area. For pixels or areas of pixels that are neighboring, i.e. have a short spatial distance, and that are similar in color, i.e. have a short distance in color space, the color change does not increase the difference in color values more than a threshold, where the threshold is a function of the color difference and the threshold in general increases as the color difference increases. In contrast, known techniques apply color changes that are only dependent on the color value of pixels or pixel areas, without taking the surrounding pixels into consideration.

In short, in the method of the invention adjacent areas with similar colors will affect each other's color enhancement such that the distance in color is only moderately changed. Adjacent similarly colored pixels or pixel areas change in color more or less in step with each other. For pixels or areas that are close together, but differ greatly in color, the method in accordance with the invention places little or no restrictions on the color change, since the threshold is high and thus the restriction on the changes in color is small or absent.

The invention is based on the following insight:

The human eye is very sensitive to changes in color and particularly to changes in the difference in color of adjacent regions. If the difference in color between pixels or pixel areas is already large to start with, or the spatial distance between the pixels or pixel areas in the image is large in the sense that the human eye perceives them as separate, a large change in difference in color between the two pixel or areas due to color enhancement is not easily spotted and does not lead to annoying visible effects. In such circumstances color enhancement methods can be applied in which quite drastic color enhancement is applied and it is not needed to moderate the color changes.

However, if the spatial distance between pixels or pixel areas is relatively small and the initial color distance is also small, i.e. the colors are alike, a large change in color distance is very often perceived as unnatural.

For adjacent regions that have widely different colors, the restriction in change is very limited or absent, since the threshold is high and thus there is hardly any limit on the color changes. Thus, for instance, colors in areas close to skin areas can undergo a very substantial color change if colors of said areas are very different from skin colors. However, for pixels and regions that are adjacent to each other and have nearly the same color, the restriction in color change of the invention is much more pronounced. After enhancement, the difference in color has changed only slightly, due to the small threshold.

As a result unnatural looking changes in color are avoided.

A further advantage is given by the fact that, since unnatural changes in difference in color, are avoided, in those areas where the spatial and/or color distances are large very considerable changes in color can be applied without negative effects in other areas of the image. In the method in accordance with the invention image areas that have a color close to skin colors and that are adjacent to image areas of skin color cannot change too much in color, even if parts of the image of the same color far away of skin colored areas do change appreciably in color.

The method of the invention puts, compared to the known techniques for color enhancement, additional restraints on the applied color enhancements. The color enhancement cannot lead, for pixels with a small spatial distance and small color distance, to an increase in color distance above a threshold. Prima facie this would seem to have a dampening effect on color enhancement, reducing the color enhancement and making images look less lively.

However, the net effect of the restraints put on the color enhancement is that the color enhancement of the image as a whole can be substantially increased. The additional restriction reduces the annoying effect of unnatural looking parts of an image, and thereby improves image quality in those areas where pixels or areas of pixel of similar color are in close vicinity to each other. This positive effect also allows the enhancement functions themselves to be made more pronounced and increase the overall color enhancement.

Thus the effect of the invention is twofold:

On the one hand the annoying unnatural effects are reduced in those areas where pixels or areas of pixels of similar color are in close vicinity to each other, thereby increasing the image quality for those areas.
On the other hand in image parts where the restraints imposed by the method of the invention are not effective more pronounced color enhancement is possible. The image quality in those areas can also be improved and the image can be made to look livelier.

In preferred embodiments for pixels or pixel areas having a color within at least one color region the color change is limited to below a maximum value, the maximum value preferably being zero or close to zero. For some colors, especially skin tones, the human eye is extra sensitive to changes. A restraint in the color changes, preferably a (near) zero color enhancement is preferred for such color regions.

In the method in accordance with the invention adjacent areas within the image that have similar color values change in a correlated manner. As a result the color distance between adjacent and similarly colored pixel and pixel areas does not increase too much.

The inventors have further realized that these correlated changes in colors could, in circumstances, for instance when use is made of very pronounced enhancement functions, lead to a situation wherein for instance a small skin colored area of the image, embedded in an image area that has a similar color, changes in color to a color outside the skin colors. The color of the originally skin colored area is then, led by the changing color in the surrounding image areas, changed to a color that is not associated with skin. The human eye is very sensitive to such effects. In preferred embodiments at least one color region, such as for instance, a skin colored color region, is ‘pinned down’ in color, i.e. restrained, wherein restraint means that the color change is limited to below a maximum value.

In this embodiment of the invention the color of areas that have colors within a ‘pinned down’ color region cannot run off to unwanted colors, because of the maximum change in color allowed.

This beneficial effect allows even more pronounced enhancement functions to be used for other colors.

The maximum allowed value of change within a protected color region can be applied in various ways. A straightforward simple restraint is an allowed color change of zero. A further simple manner is that for a pixel having color coordinates within a ‘protected color region’ the change in color coordinates is smaller than a maximum value, thus the distance in color between the initial and enhanced color coordinates is below a maximum. Another possibility is to allow the color coordinates to wander in an elliptical (if there are two color coordinates) or ellipsoidal (for three color coordinates) area or volume around the initial color coordinates. Yet another possibility is to restrict the wandering of the color to within boundaries. For color coordinates close to the boundary the allowed change would then be small if toward the boundary, but large in the opposite direction.

In further embodiments of the invention a second, third etc. color region could be protected too; an example would be a commercial logo of a company that has a defined and prescribed color. Many logos are in fact trademarks, often with well-defined colors. By restraining the color change for a second color region comprising the defined color for the logo it is avoided that the color of the logo is changed to outside the prescribed color if areas surrounding the logo happen to have a color close to the color of the logo.

In an embodiment the method of changing is performed as part of a feedback loop wherein color enhancement on an image is performed.

In another embodiment the method of changing is performed as a post-processing step for mixing an enhanced image and an original image or a less enhanced image.

In the post-processing embodiment the method of the invention is used as a way to re-introduce a natural feeling into the image. Both of the images to be mixed may have been enhanced using standard color enhancement algorithms.

A device for changing color image data according to the invention comprises a color enhancer for color enhancement of image data, wherein the color enhancer comprises a transformer for transforming color values for pixels from a color value into a transformed color value, wherein the transformer is arranged for applying color value changes to pixels in such manner that the color value changes for neighboring pixels or pixel areas are restricted to an increase of the color distance between said neighboring pixels or pixel areas below a threshold value, the threshold value being a function of the initial color distance, increasing as the color distance between neighboring pixels or pixel areas increases.

A display device according to the invention comprises an input for color image data signal, a device for changing color image data, has a display and means for displaying the enhanced color image data signal on the display.

### BRIEF DESCRIPTION OF THE DRAWINGS

These and further aspects of the invention will be explained in greater detail by way of example and with reference to the accompanying drawings, in which

FIG. 1 illustrates an original image and a color enhanced image.

FIG. 2 illustrates a 3×3 pixel area with color values

FIG. 3A is a block diagram for an embodiment of the method of the invention

FIG. 3B is a further block diagram for an embodiment of the method of the invention.

FIG. 4 illustrates an image;

FIG. 5 illustrates the gain map for the image;

FIG. 6 illustrates two 3×3 pixel areas with color values;

FIG. 7 illustrates a block diagram for an embodiment for a method of the invention;

FIG. 8 illustrates a color enhancement device of the invention;

FIG. 9 illustrates a display device in accordance with the invention.

The Figs. are not drawn to scale. Generally, identical components are denoted by the same reference numerals in the Figs.

### DETAILED DESCRIPTION OF PREFERRED EMBODIMENTS

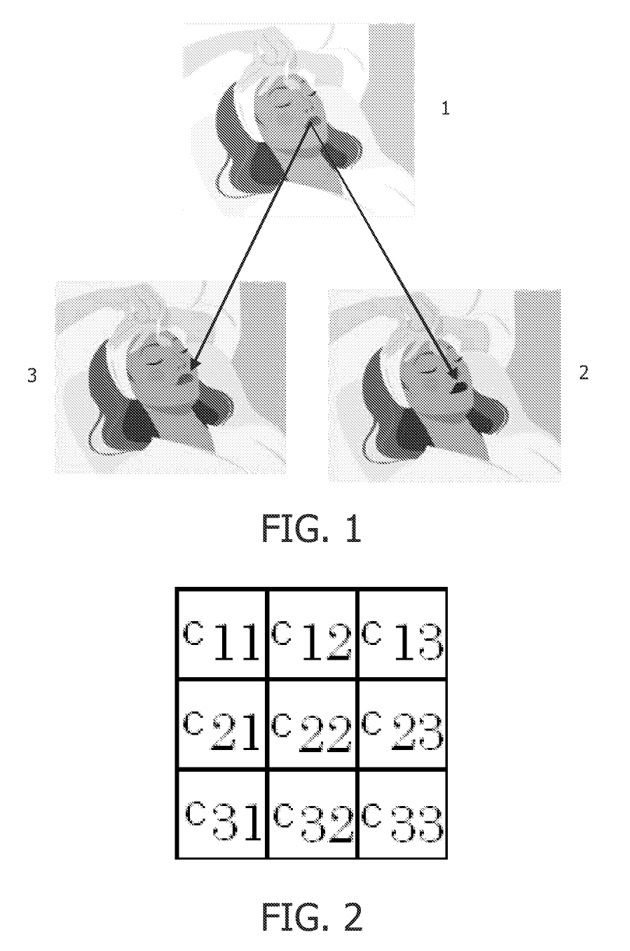

FIG. 1 illustrates three images. Number 1 illustrates an original image, number 3 an image which has been color enhanced by known methods, number 2 an image color enhanced with a method in accordance with the invention. The color enhancement has changed the image. One feature has been indicated in 1, 2 and 3; the lips have been noticeably changed in color in 2. This is a frequently occurring phenomenon in color enhancement methods. To the human eye such changes of color in lips are immediately apparent. Also frequently occurring are changes in hair color, especially for blond persons. In the method of the invention the lips form pixels or pixel area adjacent to the skin colored face and the color enhancement of the lips is restricted in such a sense that the increase in color difference between the lips and the face is below a threshold, where the threshold is a function of the color difference between the lips and the face. As a consequence, brightly colored lips, which already, as a starting point, stand out from the face and have an ‘unnatural’ look and thus show a large difference in color between the face and the lips, will be made more sparkling, as is the intended purpose of color enhancement. However, lips without lipsticks, i.e. in their ‘natural’ state, will undergo little or no color enhancement and will keep their natural look and thus the enhanced image will be more natural to the human eye. Likewise the method in accordance with the invention will prevent blond hair from becomes reddish, or, worse, giving the impression of some unnatural hair color.

In the below embodiments the CIELAB color space is used. A color space is an abstract way of representing colors, which typically incorporates three or four values or, more precisely, color components. Examples of this are YUV, RGB (Red-Green-Blue), CIELAB, etc. Different color spaces where created for specific purposes. For example, the sRGB color space was created for use in monitors, printers and the internet; the YUV color space is used currently in the analog variant of the PAL system of television broadcasting (YcbCr is the digital counterpart). The CIELAB color space intends to be perceptually linear, which means that a change of the same amount in a color value should produce a change of about the same visual importance. It is due to this perceptual linearity that the CIELAB color space is used in this examples, but other color spaces can be used as well as long as they are perceptually uniform or provide or allow good-enough approximations, depending on the application and/or available computational power. The colors of a pixel are expressed in color coordinates within the color space; color distances are expressed in differences in color coordinates or as a function of the differences in color coordinates, such as for instance the absolute values of differences in color coordinates in the color space. Such function can be a metric to convert the differences in color coordinates into a perceptive color distance compensating for the perceptual non-linearity of the used color space.

A color region is a region in color space, i.e. color coordinates within a color space within boundaries. For instance, within a color space there is a ‘green region’, i.e. all those color coordinates that correspond to a color that is perceived by the human eye as green, a skin color region, i.e. all those color coordinates that correspond to a color perceived as skin by the human eye, etc.

The spatial distance is the distance in two dimensional coordinates between the pixels.

The basic insight of the invention is that, after enhancement, the color distance between spatially connected colored pixel or pixel areas preferably does not change more than a threshold, the threshold being a function of the initial color distance, for instance in simple embodiments a percentage compared with their initial color distance. By spatially connected colors we mean the colors of pixels (or areas of an image) that are adjacent in an image, thus introducing a restraint in the enhancement algorithm obtained spatially. The initial color distance refers to the color distance between pixels (or areas) after the same amount of enhancement has been applied to both—the original image is a particular example of this, where the enhancement that is applied to both pixels (or areas) is zero. As explained above the color distance between colors of adjacent pixels (or areas in an image) can be measured simply by using the Euclidian distance in a perceptually linear color space such as the CIELAB, or by using another color distance metric that compensates for the perceptual non-linearity of the desired color space, or better suits a particular application.

In the method in accordance with the invention the maximum amount of enhancement that is applied to a certain pixel (or area) of an image depends on the color values of neighboring pixels (or areas) and possibly on their enhancements. Since the neighboring pixels (or areas) also depend themselves on their neighboring pixels (or areas), its solution becomes a Markov Random Field (MRF) problem, that can be solved in many ways.

A first example is where the method is used inside a feedback loop.

FIG. 2 illustrates the color of 9 connected original pixels (or areas) of an image, cyx, such that x and y are related to the horizontal and vertical position of the pixels (or areas) in the image, respectively.

Details of as exemplary algorithm, as part of a feedback loop that incorporates an enhancement algorithm, are stated next.

According to FIG. 2 and assuming a perceptually linear color space, we define the distances in color,

l_{yx}=∥f(c₂₂,G_{yx})−f(c_{yx},G_{yx})∥,∀_{(x,y)≠(2,2)} (1)

and

p_{yx}=∥f(c₂₂,G₂₂)−f(c_{yx},G_{yx})∥,∀_{(x,y)≠(2,2)}. (2)

f(a,b) represents a color enhancement algorithm, where a is the pixel (or area) to be enhanced and b is the color enhancement gain. Therefore, l_{yx} represents the Euclidean distance between the color of the pixel (or area) we want to enhance and the surrounding pixels (or areas), c₂₂ and c_{yx} ∀_{(x,y)≠(2,2)} respectively, after all have been enhanced by gain G_{yx} of the pixel (or area) yx. p_{yx} is the Euclidean distance between the color of the pixel (or area) we want to enhance, c₂₂, after the respective enhancement gain that we intend to determine, G₂₂; and the surrounding pixels (or areas), c_{yx} ∀_{(x,y)≠(2,2)}, after enhancement with their corresponding gains, G_{yx}.

Color enhancement gain G₂₂ is what we want to calculate and should be such that the distance p_{yx} becomes only a certain percentage larger than the distances l_{yx}, ∀_{(x,y)≠(2,2)}. Mathematically,

$${p}_{yx} = {max}_{{G}_{22}} ‖ f ( {c}_{22} , {G}_{22} ) - f ( {c}_{yx} , {G}_{yx} ) ‖ \leq ( 1 + \frac{enh}{100} ) \cdot {l}_{yx} , \\ {∀}_{( x , y ) \neq ( 2 , 2 )} \qquad ( 3 )$$

where enh is the amount of maximum enhancement between connected pixels (or areas), in percentage, thus controlling effect size. Equation (3) indicates a relation between 9 connected pixels (or areas) that intends to determine the enhancement to be applied to the center pixel (or area), G₂₂. Since this relation has to be valid for every pixel (or area) in the image, this constitutes a MRF problem and can be solved using a standard MRF solver. The maximum enhancement is restrained in the sense that color distance increase is kept below a threshold, which in this case is a percentage of the distances l_{yx}, i.e. a function of the initial color distances and increasing as the initial color distance increases. Thus, the restriction on adjacent pixels or pixel areas that have large differences in color (such as brightly colored lips in a face) is small and such brightly colored lips can be color enhanced to make them speak out even more. However, for natural lips, without lipstick, the initial color differences will be small, so the color enhancement applied to such lips will not differ much in effect from the color enhancement applied to the surrounding face and the natural look will be kept. In this example the threshold value is (enh/100) l_{yx}, but the threshold value may be a more complex function of l_{yx}. Various examples are given below. Because the natural look is kept in those areas where it matters and the unnatural look is avoided, the restriction on color enhancement that the present invention applies allows more pronounced color enhancement for other areas of the image. So the effect of the invention is not just visible around the lips, where the unnatural look is avoided, but also in other areas where more pronounced color enhancement is made possible.

It is remarked that the above example presents a fine tuned method wherein each pixel is separately dealt with; simpler methods such as methods wherein areas of pixels are considered as a whole may also be applied.

Also, in this embodiment the value enh is fixed. Within embodiments of the invention this parameter enh could be for instance
dependent on l_{yx}, allowing the restraint to be non-linearly dependent on l_{yx}. This would allow tightening the restraint for colors changes for colors that are very similar while loosening the restraint for more distinct colors
dependent on the color values of the neighboring pixels. For instance for skin colors the factor enh could be small, while for colors clearly different from skin the factor enh could be relatively large. If, for instance, an image comprises two fixed color regions, one for skin colors, and one for the color of a commercial logo presented in an upper corner of the image, the restraint for the area around the commercial logo could be less than for regions around the skin colored regions.
dependent on the whether the part of an image is in focus or not. The human eye is naturally drawn to parts of the image that are in focus. On parts of the image that are not in focus less restraints can be imposed, or no restraints at all, thus saving computing power
dependent on the data layer. 3D images are often made in a layered structure where the foreground is presented in one foreground data layer and subsequent background layers are in further background data layers. Within the concept of the invention the restraints can be different in various layers, for instance more strict in a foreground layer, and less strict or even absent, so as to safe computing power, in one or more background layers.
dependent on the position within the image, wherein for instance only for a center part of the image the method of the invention is applied. One way of doing this is to make the factor enh increase from the center, until there is no restraint. Any area outside the region of restraint then has no restraints at all and therefore does not require computing power. The human eye is naturally drawn to a centre part of the image.
dependent on the intensity of the image, the restraint could be made less severe, or even zero, for images or image parts of relatively low light intensity, for instance below a lower threshold in light intensity

The threshold value increases as the color distance between neighboring pixels or pixel areas increases. Such increase could be in the form of step function, wherein the threshold value has a first constant value for differences in color below a first value, a second, higher, constant value for differences between said value and a second value, and stepwise increases as the difference in color increases, a highest value applicable for any difference color above a highest difference value.

Any combination of the above possibilities are also embodiments of the invention.

A computationally cheap approximation of a MRF solver is a propagation algorithm and is used in the remainder of this embodiment by way of example.

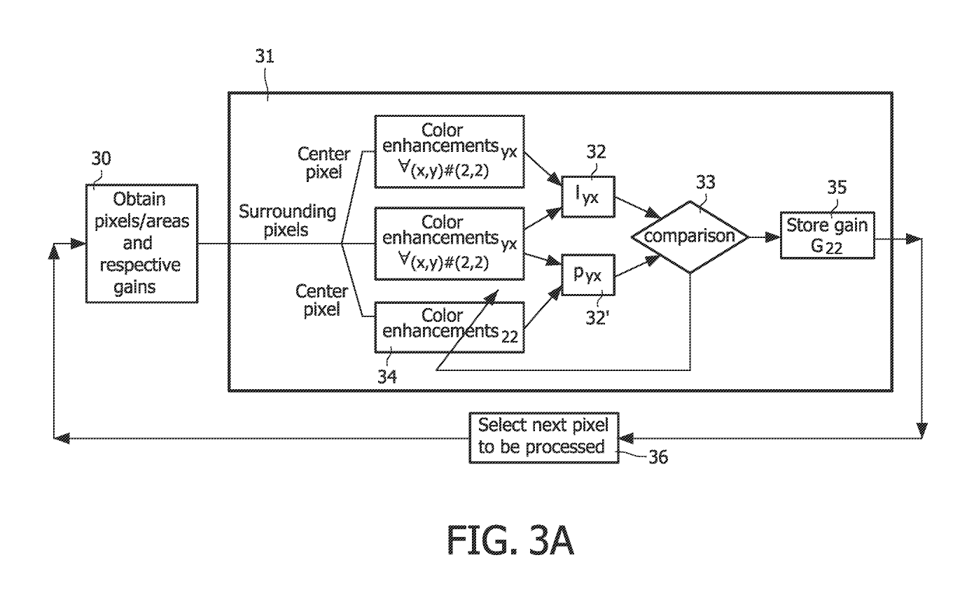

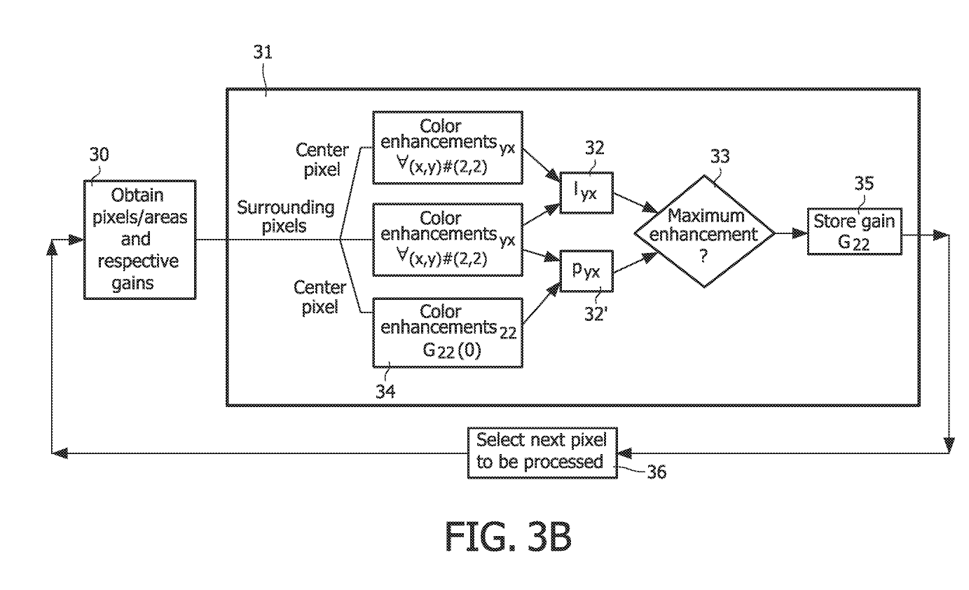

FIGS. 3A and 3B show the block diagrams which incorporate enhancements.

These Figs. show two possible ways of processing within the framework of the invention. One is to process pixels in series as shown in FIG. 3A, and the other is a parallel process shown in FIG. 3B.

In the first step 30 pixel or pixel areas with their color values and respective gains are gathered. Then in part 31 color enhancements_{xy} from a surrounding pixel are applied to both the centre pixel and the surrounding pixels. The value l_{yx}=∥f(c₂₂,G_{yx})−f(c_{yx},G_{yx})∥,(x,y)≠(2,2) is calculated in step 32. Similarly, p_{yx}=∥f(c₂₂,G₂₂)−f(c_{yx},G_{yx})∥,(x,y)≠(2,2) is calculated with color enhancement₂₂ in step 32′.

If it is established in comparison step 33 that

$${p}_{yx} > ( 1 + \frac{enh}{100} ) \cdot {l}_{yx} ,$$

the color enhancement for the centre pixel has to be reduced in step 34. Subsequently the calculation steps 32 and comparison step 33 and possibly reduction step 34 can be repeated for each surrounding pixel. After the iterations of all surrounding pixels, the gain for the centre pixel is stored in step 35 and the next pixel to be processed is selected in step 36. The step 36 of “select next pixel to be processed” determines the iterative order of the pixels in the image.

The above exemplified procedure of FIG. 3A works in series.

Parallel processing is an alternative solution as shown in FIG. 3B. With some initial gain G₂₂(0), all enhancements from surrounding pixels are processed in parallel and sent to step 34, where the maximum enhancement is found by formula 3.

In this example, gain G_{yx} is saved and used to calculate color enhancement f(c_{yx},G_{yx}) every time. For computational consideration, color enhancement results can be saved directly.

In these examples a 3×3 pixel matrix has been used. This is not a limitation, other pixel matrices, such as 5×5, or more in general N×N matrices may be used. Also matrices of the type N×M, where N≠M, i.e. rectangular matrices, may be used. In larger matrices the centre pixel is surrounded by a number of shells of pixels, the nearest pixels, the next nearest pixels, the next-next nearest pixels etc. The maximum enhancement allowed may be made dependent on the shell. In the present example this could for instance be implemented in such manner that for surrounding pixels in a further shell of surrounding pixels the restricting factor enh may be larger, although preferably only moderately larger, than for the shell of pixels nearest to the centre pixel.

Although the color enhancement function, f(.,.), can be any function in the literature (for example those described in [2]), as a way to exemplify the algorithm we define the function ƒ(.,.) in the CIELAB color space as,

$$f ( color , G ) = \{ \begin{matrix}{color}_{lab} \\ {color}_{{a}^{*}} \cdot G \\ {color}_{{b}^{*}} \cdot G ,\end{matrix} \qquad ( 4 )$$

where the color components a* and b* are simply multiplied by the gain G.

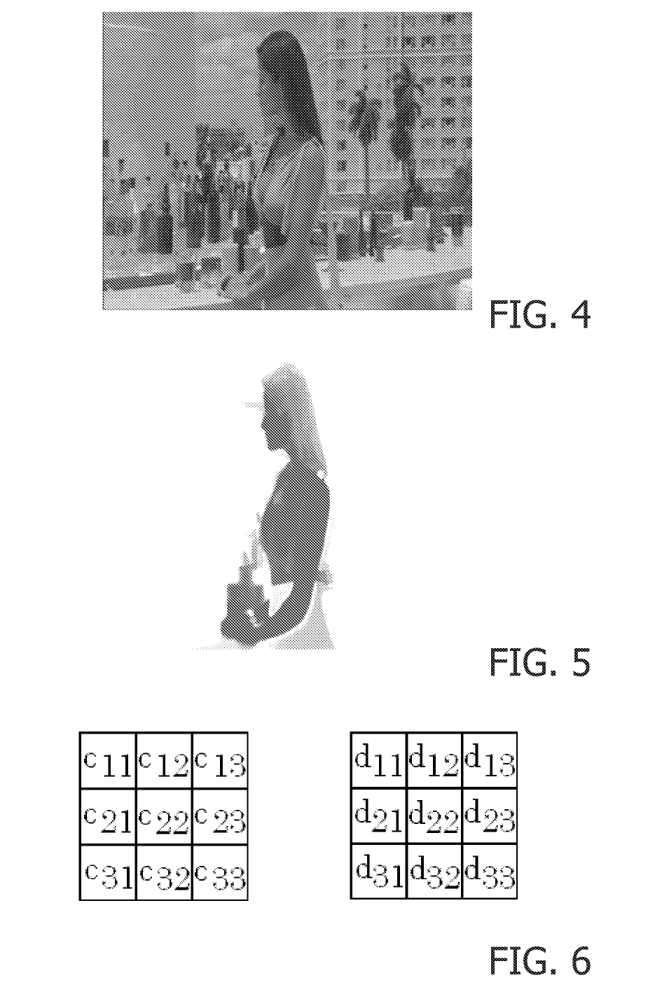

In preferred embodiments of the invention the gain for one or more color regions is defined and fixed, or at least bound to a maximum. Such color regions will thus not differ in gain and will serve as an anchor in the method. In embodiment of the invention it is defined that the skin regions should have a gain of 1. FIGS. 4 and 5 illustrate the effect of setting the skin regions to have a gain of 1. The gain map shows the gain wherein black stands for a gain of 1, and the brighter the region, the higher the gain.

Dark regions are less enhanced than brighter regions, due to the color distance restraint.

The hair as well as the dress of the person is hardly color enhanced due to the color distance restraint.

Above it is explained that in images the lips and hair can be provided with a more natural look. FIGS. 4 and 5 show yet another example of the advantage of the method. Clothing, especially women dresses, are often chosen in such colors to either match the color of the skin, or to contrast with it. The method of the invention preserves this distinction. In FIG. 5 the gain map shows that the dress has substantially the same color gain as the skin colored parts. Consequently the intended match between the dress and the skin is preserved. Although it may not be seen on the black and white image shown in FIG. 4, the top of the dress matches a skin color, but the bottom part is blue, which clearly contrast with skin. In the method of the invention this blue part is made livelier, i.e. is provided with a substantial color enhancement.

In the above example the method is used in a loop, i.e. during the color enhancement.

In another example the color algorithm is used outside a feedback loop

The details of an exemplary algorithm as a post-processing of given color enhancement algorithms, is stated next. It intends to find a proper way to mix between an image that was not very enhanced (or not at all) and still looks natural, and an image that has been much enhanced, but looks un-natural.

FIG. 6 illustrates the color of 9 connected pixels (or areas) of an image, cyx and dyx, such that x and y are related to the horizontal and vertical position of the pixels (or areas) in the image, respectively. The c pixels (or areas) represent the pixels after some enhancement (that can be zero, if it is the original image), and the d pixels (or areas) represent the same pixels (or areas) after a larger enhancement.

Using FIG. 6 and assuming a perceptually linear color space, we define the distances,

l_{yx}=∥[(1−α_{yx})·c_{yx}+(α_{yx})·d_{yx}]−[(1−α_{yx})·c₂₂+(α_{yx})·d₂₂]∥,∀_{(x,y)≠(2,2)} (5)

and

p_{yx}=∥[(1−α_{yx})·c_{yx}+(α_{yx})·d_{yx}]−[(1−α₂₂)·c₂₂+(α₂₂)·d₂₂]∥,∀_{(x,y)≠(2,2)} (6)

αε[0,1] indicates the amount of linear mixing between a certain low-enhanced pixel (or area) c_{yx} and a largely enhanced pixel (or area) d_{yx} and, the larger it is, the more enhancement is applied to the particular pixel (or area). It is, therefore, somewhat of an enhancement gain. Therefore, l_{yx} represents the Euclidean distance between the color of the pixel (or area) we want to enhance and the surrounding pixels (or areas), c₂₂ and c_{yx} ∀_{(x,y)≠(2,2)} respectively, after all have been mixed with the factor α_{yx} of the pixel (or area) yx. p_{yx} is the Euclidean distance between the color of the pixel (or area) we want to enhance, c₂₂, after the respective mixing factor that we intend to determine, α₂₂; and the surrounding pixels (or areas), c_{yx} ∀_{(x,y)≠(2,2)}, after enhancement with their corresponding mixing factors, α_{yx}.

Color enhancement mixing α₂₂ is what we intend to calculate and should be such that the distance p_{yx} becomes only a certain percentage larger than the distances l_{yx}, ∀_{(x,y)≠(2,2)}. Mathematically,

$${p}_{yx} = {max}_{{α}_{22}} ‖ [ \begin{matrix}( 1 - {α}_{yx} ) \cdot {c}_{yx} + \\ ( {α}_{yx} ) \cdot {d}_{yx}\end{matrix} ] - [ \begin{matrix}( 1 - {α}_{22} ) \cdot {c}_{22} + \\ ( {α}_{22} ) \cdot {d}_{22}\end{matrix} ] ‖ \leq ( 1 + \frac{enh}{100} ) \cdot {l}_{yx} , \\ {∀}_{( x , y ) \neq ( 2 , 2 )} \qquad ( 7 )$$

where enh is the maximum amount of enhancement, in percentage, thus controlling effect size. Equation (7) indicates a relation between 9 connected pixels (or areas) that intends to determine the enhancement to be applied to the center pixel (or area), G₂₂. Since this relation has to be valid for every pixel (or area) in the image, this constitutes a MRF problem and can be solved using a standard MRF solver.

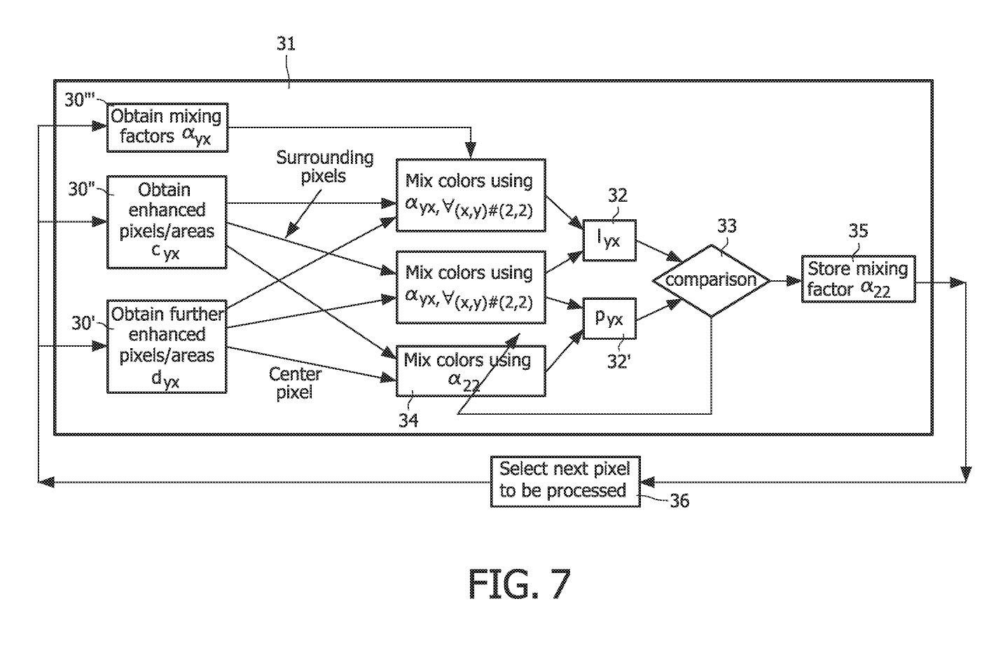

FIG. 7 shows a block diagram for such an out-of-loop method. In steps 30′, 30″ and 30′″ c_{xy} pixels (or areas) representing the pixels after some enhancement (that can be zero, if it is the original image), and the d_{xy} pixels (or areas) representing the same pixels (or areas) after a larger enhancement as well as mixing factors α_{xy}. These steps are here represented as separate steps, to separately indicate the various data. Equivalent to what is described in FIG. 3A two quantities l_{yx} and p_{yx} are calculated in calculation steps 32 and 32′ using formulae 5 and 6 above, in comparison step 33 it is checked whether formula 7 holds, and, if needed in adjustment step 34 the color enhancement mixing factor α₂₂ is adjusted. If the comparison checks out, the color enhancement mixing factor α₂₂ is stored and the next pixel to be processed is selected.

The invention relates to a method as described above.

The invention also relates to a device for color enhancing an image, said device comprising a color enhancer for color enhancement of image data. In accordance with the invention such a device is characterized in that the color enhancer comprises a transformer for transforming color values for pixels from a color value into a transformed color value, wherein the transformed is arranged for applying color value changes to pixels in such manner that the color value changes for neighboring pixels or pixel areas are restricted to an increase of the color distance between said neighboring pixels or pixel areas below a threshold value, the threshold value being a function of the initial color distance, increasing as the color distance between neighboring pixels or pixel areas increases.

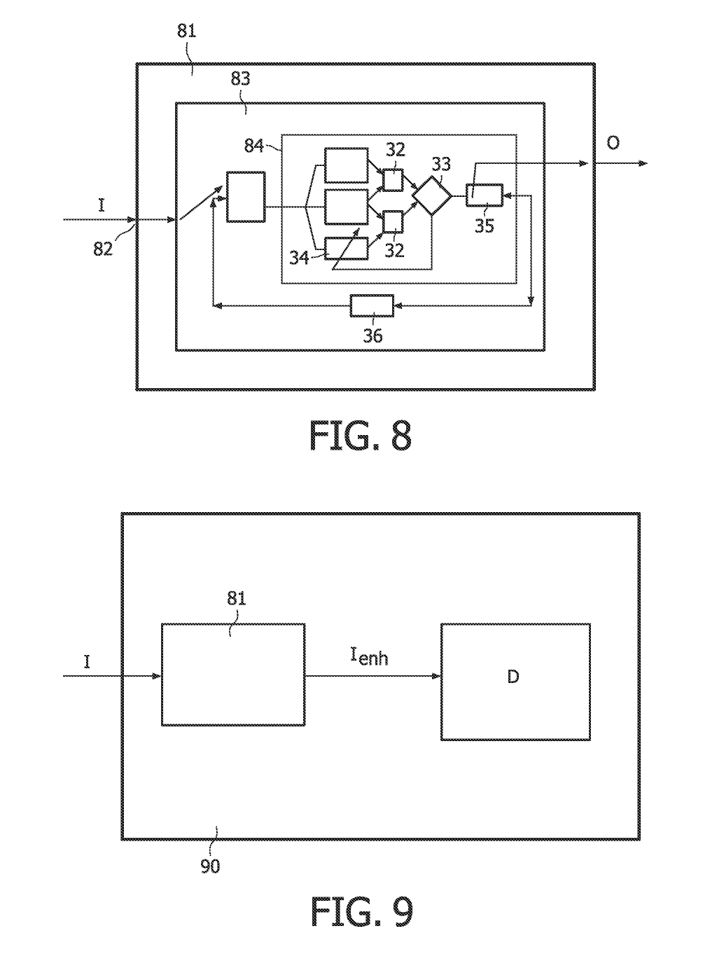

FIG. 8 illustrates such a device.

The device 81 has an input 82 for an image signal I, and a color enhancer 83. The color enhancer 83 comprises a transformer 84, operating in accordance with the method of the invention, which is schematically indicated by one of the block diagrams, in this example, by a simplified version of the block diagram of FIG. 3A. The color enhancer provides an output providing the gains for the various pixels. These gains values can then be used to provide an output image signal O. Alternatively the gains can be attached as a separate data stream to the original incoming signal, allowing a device to which the data stream is sent to use the original or the improved data.

The device for color enhancement can be part of any device that records an image signal, that transforms an image signal or that receives an image signal. Color enhancement can be done for instance in a camera to immediately enhance the colors of a recorded image, it can be done to provide an improved version of an image, wherein in the framework of the invention images can be photos as well as video sequences. Such a color enhancement device could for instance have an input with a non-enhanced image, and an output providing a color enhanced image signal, which enhance image signal is then stored on a disk or another medium for storing data, or directly sent to an image treating device. Image treating devices are for instance display devices, but also printing devices. In embodiment the device may have an input for setting threshold parameters for the method of the invention. Such parameters are for instance the factor enh, or the color regions to be pinned down, the maximum gain allowed for pinned down color regions, or the luminance value below which restraints are no longer taken into account or any other parameter.

The invention is also embodied in a display device comprising a device for color enhancement in accordance with the invention, for color enhancing an input image signal.

FIG. 9 illustrates a display device 90 in accordance with the invention. The display device comprises a color enhancer 81 for enhancing an input image signal Ito a color enhanced image signal Iₑₙₕ. The color enhancer is a color enhanced for color enhancing in accordance with the method of the invention. The enhanced signal provides for a color enhanced image on image screen D of display device 90.

In the claims, any reference signs placed between parentheses shall not be construed as limiting the claim.

In short the invention can be described as follows:

In a method for color enhancement the color distance between spatially close colored pixel or pixel areas does not change more than a threshold, the threshold being a function of the initial color distance. The change in color difference between pixels that are close together and did not differ much in color will be restricted. This reduces the change on unnatural looking parts of an image and allows a more pronounced color enhancement to be used.

The invention is also embodied in a computer program comprising program code means for performing a method for changing an image data signal and in a computer program product comprising program code means stored on a computer readable medium for performing a method for changing an image data signal.

The word “comprising” does not exclude the presence of other elements or steps than those listed in a claim. The invention may be implemented by any combination of features of various different preferred embodiments as described above. The word “pixel’ is not to be considered as restrictive, ‘pixel’ may be any data assigning a color to any part of an image, including subpixels or a group of pixels.

1. Method for changing an image data signal comprising pixel data, the pixel data comprising a color value, in which method the color values for pixels or pixel areas are transformed from a color value into a transformed color value, wherein the color value changes to pixels are applied in such manner that the color value changes for neighboring pixels or pixel areas are restricted by an increase of the color distance between said neighboring pixels or pixel areas below a threshold value, the threshold value being a function of the initial color distance, increasing as the color distance between neighboring pixels or pixel areas increases.

2. Method for changing an image data signal as claimed in claim 1, wherein for pixels or pixel areas having a color within at least one color region the color change is limited to below a maximum value.

3. Method for changing an image data signal as claimed in claim 2, wherein the maximum value is zero.

4. Method for changing an image data signal as claimed in claim 2, wherein the said color region is a color region comprising skin colors.

5. Method for changing an image data signal as claimed in claim 1, wherein the method is performed as part of a feedback loop wherein color enhancement on an image data signal is performed.

6. Method for changing an image data signal as claimed in claim 1, wherein the method of the invention is performed outside a feedback loop.

7. Method for changing an image data signal as claimed in claim 6, wherein a color enhanced image and a less color enhanced image are mixed.

8. Device (81) for color changing color image data (I), said device comprising a color enhancer (83) for color enhancement of image data, wherein the color enhancer (83) comprises a transformer (84) for transforming color values for pixels from a color value into a transformed color value, wherein the transformer is arranged for applying color value changes to pixels in such manner that the color value changes for neighboring pixels or pixel areas are restricted to an increase of the color distance between said neighboring pixels or pixel areas below a threshold value, the threshold value being a function of the initial color distance, increasing as the color distance between neighboring pixels or pixel areas increases.

9. A device for changing color image data as claimed in claim 8, wherein the color enhancer (83) is arranged such that for pixels having a color within at least a color region the color change is limited to below a maximum value.

10. A device as claimed in claim 9, wherein the maximum value is zero.

11. A display device comprising an input for color image data signal, a device for changing color image data as claimed in claim 8, and having a display and means for displaying the enhanced color image data signal on the display.

12. Computer program comprising program code means for performing a method for changing an image data signal as claimed in claim 1 when said program is run on a computer.

13. Computer program product comprising program code means stored on a computer readable medium for performing a method for changing an image data signal as claimed in claim 1, when said program is run on a computer.
